(19) United States
(12) Patent Application Publication
(10) Pub. No.: US 2026/0208460 A1
(43) Pub. Date: Jul. 23, 2026

(54) METHOD FOR MANUFACTURING A COMPOSITE LEAF SPRING AND USE OF SUCH A LEAF IN A VEHICLE SUSPENSION SYSTEM

(71) Applicant: Newtton, Fareins (FR)

(72) Inventor: Matthieu Alfano, Fareins (FR)

(21) Appl. No.: 19/143,109

(22) PCT Filed: Dec. 27, 2023
(86) PCT No.: PCT/EP2023/087818

§ 371 Date: Jun. 25, 2025

(30) Foreign Application Priority Data
Dec. 26, 2022 (FR) FR2214495

(51) Int. Cl. B29D 99/00; B29K 307/04; B60G 11/02

(52) U.S. Cl. CPC B29D 99/0007; B29K 2307/04; B60G 11/02; B60G 2202/11; B60G 2206/428; B60G 2206/7101; B60G 2206/8103; B60G 2206/8106; B60G 2206/85; B60G 2300/12

(57) ABSTRACT

A method for manufacturing a composite leaf spring comprising a leaf body having a lower surface and, at each end, an attachment end piece for fastening the leaf spring to a suspension system, wherein the leaf body is produced by curing a fiber-reinforced matrix, and, prior to the operation for curing the matrix, deformable reinforcing fibers are applied to a support surface having a curvature that defines the lower surface of the leaf spring in the rest state, the reinforcing fibers being arranged in parallel with one another and extending along the curvature of the support surface in order to form, after curing, an arrangement of continuous reinforcing fibers that are parallel to one another and oriented in the longitudinal direction of the leaf body.

### CROSS-REFERENCE TO RELATED APPLICATIONS

This application is a national phase entry under 35 U.S.C. § 371 of International Patent Application PCT/EP2023/087818, filed Dec. 27, 2023, designating the United States of America and published as International Patent Publication WO 2024/141538 A1 on Jul. 4, 2024, which claims the benefit under Article 8 of the Patent Cooperation Treaty of French Patent Application Serial No. FR2214495, filed Dec. 26, 2022.

### TECHNICAL FIELD

The present disclosure relates to a method for manufacturing a composite leaf spring comprising a leaf body having a lower surface and, at each end, an attachment end piece for attachment to a suspension system.

### BACKGROUND

The leaf spring manufactured according to the method of the present disclosure is intended for use in a vehicle suspension system and, in particular, but not exclusively, in a suspension system for a cycle, automobile, scooter or motorcycle.

The purpose of vehicle suspension is to compensate for irregularities in the surface over which the vehicle travels, reducing the impact thereof on the vehicle, preventing mechanical fatigue and excessive wear, maintaining contact between the wheels and the ground despite irregularities therein, and improving driving comfort.

As is known, in the case of a cycle, a suspension is composed of an energy dissipation system that ensures shock absorption, typically provided by hydraulic fluid pressure or mechanical friction, and an elastic system opposing wheel displacement and ensuring the return thereof to the point of equilibrium.

The elastic system must be able to softly oppose displacement of the wheel around its equilibrium position in order to ensure high sensitivity to small impacts (vibration filtration), but also be capable of firmly opposing larger impacts in order to prevent bottoming out, i.e., the suspension reaching the end of its travel and no longer performing its purpose. The visualization of the force (in N) of the elastic system in opposition to the displacement of the wheel in the absence of energy dissipation (i.e., without considering the energy dissipation system) is called the static compression curve (or traction in the case of a “tensioned” elastic system). This is referred to as static suspension behavior.

Among the elastic systems used, the one used in the suspension system described in application WO2016/207570 is known, and takes the form of an elastic leaf that is elastically deformable between a rest state in which the spring has a curved profile and a state of maximum extension in which the spring has an elongate profile, the length of which corresponds to that of the neutral axis of the spring, the leaf transitioning from the rest state to the extension state via intermediate extension states in which the leaf has profiles that are decreasingly curved.

The advantage of this type of leaf spring is, in particular, that it affords a suspension system with improved reliability, compactness and performance, as well as adaptable behavior depending on the desired sensitivity, travel, stiffness, progressivity, type of use, etc.

The aim of the present disclosure is to improve on the elastic system proposed in the above-mentioned application in terms of strength and behavior.

### BRIEF SUMMARY

To this end, the present disclosure provides a method for manufacturing a composite leaf spring having a lower surface and, at each end, an attachment end piece for fastening the leaf spring to a suspension system, wherein the leaf body is produced by curing a fiber-reinforced matrix, the method being characterized in that, prior to the operation of curing the matrix, deformable reinforcing fibers are applied to a support surface having a curvature that defines the lower surface of the leaf spring in the rest state, the reinforcing fibers being arranged in parallel with one another and extending along the curvature of the support surface in order to form, after curing, an arrangement of continuous reinforcing fibers that are parallel to one another and oriented in the longitudinal direction of the leaf body, at least at the lower surface of the leaf body.

In the present description, the term “deformable fiber” means a fiber with stretch properties of at least 2%.

Thus, by giving the reinforcing fibers the right shape before they are assembled together by positioning them on the support surface corresponding to the lower surface of the desired leaf spring, and by orienting them unidirectionally on the support surface, a leaf spring is produced that has all of the reinforcing fibers perfectly aligned and oriented in the longitudinal direction of the leaf (0° with respect to the longitudinal axis of the leaf).

Advantageously, the leaf body is formed of one or more overlaid layers of reinforcing fibers.

Advantageously, the plurality of layers of fibers is obtained by one or more consecutive operations of folding, turning or winding one or more strips of fabric arranged on the support surface and containing unidirectional reinforcing fibers extending in the longitudinal direction of the strips.

Advantageously, the attachment end pieces are produced by arranging a pin on the one or more strips of fabric on either side of the support surface prior to folding, turning or winding. Depending on whether the pins are then retained in the finished leaf spring or removed therefrom, the result is either a leaf spring in which the insert is integrated into the leaf, or “embedded” in the fiber, or a 100% composite leaf spring. If the insert is integrated, it will have a tubular cross section.

Advantageously, the attachment end pieces are secured to the leaf body once the latter has been produced.

Advantageously, the method further comprises an operation of lacing the reinforcing fibers with one or more retaining fibers over all or part of the length of the fibers, the lacing being carried out in such a way as to arrange the retaining fiber at a non-zero angle with respect to the orientation of the fibers (i.e., in such a way as to arrange the retaining fiber so that it is not aligned with the reinforcing fibers).

Advantageously, the one or more retaining fibers are laced around the reinforcing fibers at the point where the attachment end pieces join the leaf body. The lacing of the reinforcing fibers prevents or at least reduces the effects of delamination. The “lacing” allows delamination forces to be “taken up,” making the leaf less sensitive thereto.

Advantageously, the lacing is carried out in such a way as to arrange the retaining fiber at an angle of between 45 and 90 degrees with respect to the orientation of the reinforcing fibers, and preferably at 90 degrees.

Advantageously, the retaining fiber has a higher stiffness than the reinforcing fibers.

Advantageously, the method comprises a step of assembling a plurality of elementary leaf bodies or elementary one-piece leaves arranged so as to be laterally contiguous with respect to one another and/or butted against one another. A one-piece leaf is a leaf where the attachment end pieces are formed in one piece with the leaf body.

Advantageously, the reinforcing fibers are glass, KEVLAR®, aramid, polyethylene and/or PBO ZYLON® fibers.

Advantageously, the retaining fiber is a carbon fiber.

The present disclosure also relates to a composite leaf spring obtained using the manufacturing method described above. The composite leaf spring manufactured according to the method is advantageously a leaf spring that is elastically deformable between a rest state in which the leaf spring has a curved profile and a state of maximum extension in which the leaf spring has an elongate profile, the length of which corresponds to that of the neutral axis of the leaf spring. Such a leaf spring is known as a “tension” leaf spring.

The present disclosure also relates to the use of a leaf spring obtained according to the manufacturing method described above in a suspension system. It is thus an initially curved leaf that is tensioned.

### BRIEF DESCRIPTION OF THE DRAWINGS

Other features and advantages of the present disclosure will emerge from the following detailed description of the present disclosure with reference to the accompanying figures, and in which:

FIG. 1 shows a schematic ¾ perspective view of a composite leaf spring obtained according to the manufacturing method of the present disclosure;

FIG. 2 shows a perspective view of a jig used to produce the leaf spring of FIG. 1;

FIG. 3 shows a cross-sectional view of the jig of FIG. 2 along the median plane;

FIGS. 4A-4E show the steps in producing a three-layer composite leaf spring according to a first embodiment;

FIG. 5 shows a schematic view of the arrangement of the unidirectional fibers for forming the leaf body of FIG. 1 before the operation of lacing with the retaining fiber;

FIG. 6 shows a three-layer composite leaf spring according to one variant;

FIG. 7 shows a three-layer composite leaf spring according to another variant;

FIG. 8 shows a four-layer composite leaf spring obtained according to another folding variant; and

FIG. 9 shows a composite leaf spring according to one variant of the present disclosure.

For greater clarity, identical or similar elements of the various embodiments are denoted by identical reference signs in all of the figures.

### DETAILED DESCRIPTION

With reference to the figures, a method is described for manufacturing a composite leaf spring 1 comprising a leaf body 2 provided, at each end, with an attachment end piece 3 allowing the leaf spring 1 to be attached to a suspension system of a cycle-type vehicle.

The leaf spring 1, in the example described, is formed of a plurality of layers of unidirectional fibers, which are advantageously continuous over the entire length of the strip, the fibers being completely or partly laced with a retaining fiber, a plurality of retaining fibers or a retaining strip containing retaining fibers. Unidirectional fibers are fibers oriented in the same direction.

The unidirectional fibers are deformable fibers selected to confer the desired degree of flexibility on the composite leaf. To ensure that the unidirectional fibers are held together, the retaining fiber advantageously has a higher stiffness than the unidirectional fibers. This prevents delamination of the leaf spring. Advantageously, the unidirectional fibers are glass, KEVLAR®, aramid, polyethylene and/or PBO ZYLON® fibers; the one or more retaining fibers are preferably carbon fibers.

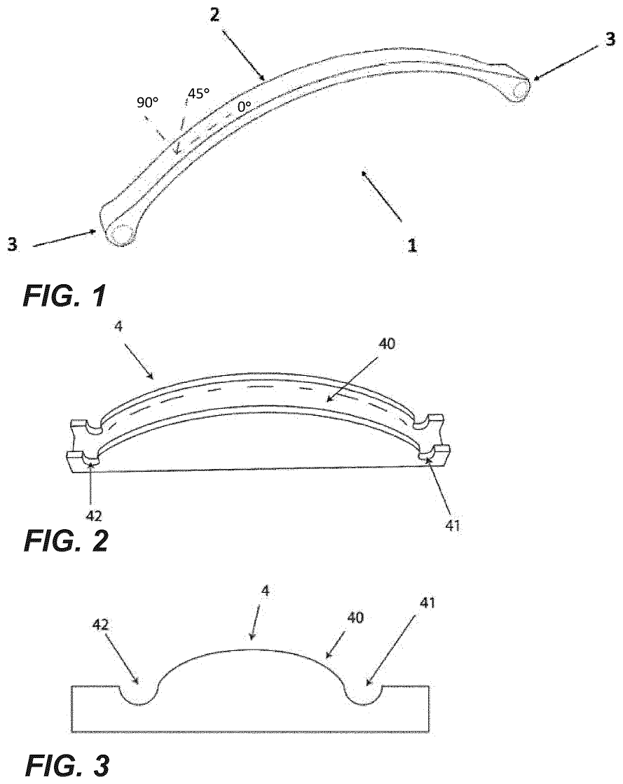

FIG. 1 shows an elastically deformable leaf spring 1 obtained according to the method that is the subject of the present disclosure. The leaf spring 1, shown at rest, has a curved shape defining an outer, convex surface (upper surface) and an inner, concave surface (lower surface).

In the following, the manufacturing method is described according to a non-limiting example in which the unidirectional layers of fibers are pre-impregnated unidirectional fiber fabric layers. The method according to the present disclosure is, of course, not limited to the use of impregnated fabrics, and the infusion technique for producing the leaf body can be implemented without departing from the scope of the present disclosure. Depending on whether the layers applied are pre-impregnated fabrics, dry fabrics containing fibers, or fibers positioned singly, the conventional steps of the process are then implemented (“pre-impregnated” process: curing, possibly under vacuum, to ensure polymerization of the resin contained in the one or more layers of pre-impregnated fabrics; “infusion” process: placing the dry fabrics or fibers in a bag under vacuum, and drawing and diffusing the resin through the bag as a result of the vacuum).

The leaf spring is produced on a jig arranged so as to give the leaf spring the desired shape and curvature. FIGS. 2 and 3 illustrate an example of a jig 4. This has a convex support surface 40 with an arc of curvature corresponding to the profile of the leaf spring 1 in the rest state once it has been obtained. The curvature of the support surface 40 defines the lower surface shape of the leaf spring 1 in its rest state.

In the example described, the jig has two receiving notches 41, 42 located on either side of the support surface 40, each intended to accommodate an insert or pin to produce the attachment end pieces. This is, of course, only an example, and it is possible for the support on which the fibers are formed not to include such notches.

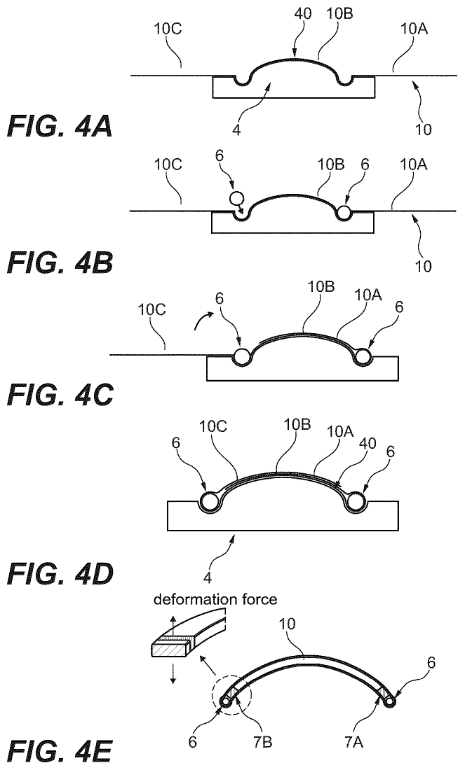

In the exemplary embodiment described below, the steps of which are illustrated in FIGS. 4A-4E, the leaf spring 1 is a leaf spring comprising three pre-impregnated unidirectional fiber layers 10A, 10B, 10C obtained from one and the same fabric strip 10 of pre-impregnated fabric of a length greater than the length of the support surface 40 of the jig. This is, of course, a non-limiting example, as the dimensions of the jig may be greater than or equal to those of the fabric strip.

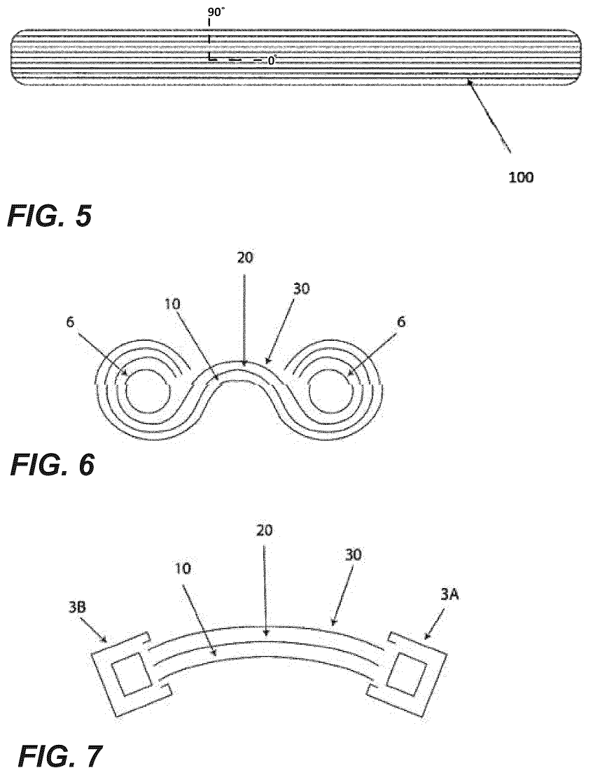

The leaf spring 1 is produced by arranging the pre-impregnated fabric strip 10 on the support surface 40, the portions extending outside the jig 4 being of substantially the same length (FIG. 4A). As illustrated in FIG. 5, the fabric strip 10 is positioned so that the unidirectional fiber layers 100 of the strip extend parallel to one other along the curvature of the support surface 40.

Two tubular inserts 6 are then positioned on the fabric strip 10, respectively, in each of the receiving notches 41, 42 provided for this purpose in the jig 4 (FIG. 4B). Once in place, the inserts 6 divide the fabric strip into three portions: a central layer 10B extending between the two inserts 6 and resting on the support surface 40, and two portions extending on either side of the inserts 6 (referred to as end flaps 10A, 10C). Each of these portions will define the layers 10A, 10B and 10C.

The three layers 10A, 10B, 10C are then obtained by folding the fabric strip 10, by folding one of the end flaps 10A over the central layer 10B of the strip and then folding the opposite end flap 10C over the folded-over end flap 10A (FIGS. 4C and 4D). The length of the fabric strip will be selected so as to obtain three overlaid layers after folding of the end portions, the three layers being formed by the overlaying of the central portion and the end portions. Advantageously, the fabric strip will be approximately 3 to 3.5 times longer than the length of the leaf spring 1 obtained when in its rest state. The advantage of this folding layup technique is that the functional thickness of the central portion defining the leaf body is three times greater than the thickness at the ends. The resulting leaf spring thus has compact ends.

As this is a pre-impregnated fabric, the layers bond together under the effect of pressure exerted when the layers are laid and folded on top of one another.

At the end of the folding operation, the inserts 6, integrated between the layers, form the attachment end pieces 3 of the leaf spring 1. According to one variant, temporary pins can be provided, which are intended to be removed after completion of the operation of folding the strips of fabric, either before the operation of laying up the leaf body 2 with a retaining strip, or after the layup operation.

The assembly formed is then removed from the jig 4. A retaining fiber is then laced around the overlaid layers, at least at the point where the attachment end pieces join the leaf body 2, since this portion is the most sensitive to delamination forces. The retaining fiber is placed over the pre-impregnated fabric layers to have a fiber orientation different from that of the pre-impregnated fabric layers. The retaining fiber, positioned in this way relative to the pre-impregnated fabric layers, ensures that the fibers of the layers are held in place whatever the state of stress of the leaf spring when it is used in a suspension system (rest, compression or tension), preventing the unidirectional fibers from separating from one another and thereby reducing the risk of delamination of the fabric layers.

According to one advantageous embodiment, the retaining fiber is arranged around the pre-impregnated fabric layers such that the retaining fiber is oriented in a range between 45 degrees and 90 degrees with respect to the fibers of the pre-impregnated fabric layers, and advantageously 90 degrees. In the example shown, the retaining fiber is arranged at 90 degrees to the unidirectional fibers of the pre-impregnated fabric layers (FIG. 4E). The retaining fiber shown is advantageously positioned at each end of the leaf body 2, at the point where the attachment end piece joins the leaf body (FIG. 4E). Of course, this is only an example, and provision may be made to lay up the leaf body 2 over all or part of its length with a retaining strip. Indeed, the greater the area covered by the lacing, the greater the take-up of delamination forces and the higher the performance of the leaf spring.

In the example just described, the leaf spring is a three-layer leaf formed from a single strip of fabric via folding layup. FIG. 6 shows an example of a leaf spring according to the present disclosure comprising three pre-impregnated unidirectional fiber fabric layers, produced from three separate strips of fabric (overlay layup).

The leaf spring is produced as follows. The strips of fabric are arranged on the support surface 40 of the jig 4, overlaid over one another. As before, two inserts 6 are then positioned on the strip, in each of the insert-receiving notches. The inserts may be either permanent inserts 6 or temporary inserts. Each strip is then folded over, starting with the top strip and ending with the bottom strip. The top strip is the one farthest away from the jig 4, and the bottom strip is the one closest to the jig 4 (in the example, this is the strip in contact with the jig 4). In this example, the strips have a defined length so that the ends of the end sections, once folded, are positioned in the vicinity of the inserts 6. The layers are then laid up with the retaining strip.

In the case of overlay layup, layers of fibers of different stiffnesses can be overlaid over the support surface. The compactness of the energy storage of the leaf spring will thus be all the greater as the stiffness of the fibers increases away from its lower surface.

In the previously described embodiments, the attachment end pieces 3 are formed by the folded portions of the strips. They are thus formed in one piece with the leaf body 2 (integrated end pieces). The choice of producing integrated end pieces, and thus of producing a one-piece leaf spring, improves reliability thereof, as the risk of leaf/end piece separation failure is reduced.

In another variant, the attachment end pieces are elements added to the leaf body 2. An example of such a three-layer leaf spring 1 is shown in FIG. 7. In this example, the leaf spring 1 is a three-layer leaf spring produced by overlaying three separate pre-impregnated fabric strips 10, 20, 30. The length of the strips substantially corresponds to the length of the leaf body 2. In the example described, the length corresponds to the length of the support surface 40 of the jig 4. The leaf spring 1 is produced by first producing the leaf body 2. To do this, the same operations are carried out as in the previously described example, namely the operation of overlaying fabric strips 10, 20, 30, followed by the operation of covering all or part of the layers by arranging one or more retaining strips around the layers. Once the leaf body 2 has been produced, an end piece 3A, 3B is secured to each end of the leaf body 2. It is secured by any means known to a person skilled in the art.

The examples described above relate to the production of a leaf spring wherein the leaf body 2 is made up of three layers of pre-impregnated fabric. It goes without saying that the leaf spring 1 is not limited to three layers of pre-impregnated fabric, and that it may comprise one or two layers, or more than three layers, which can be produced by folding strips, or a number of strips corresponding to the number of layers desired. When production is by folding a plurality of strips, the layers of pre-impregnated fabric are obtained by consecutively folding end portions of the strips over the top strip, from the top strip to the bottom strip.

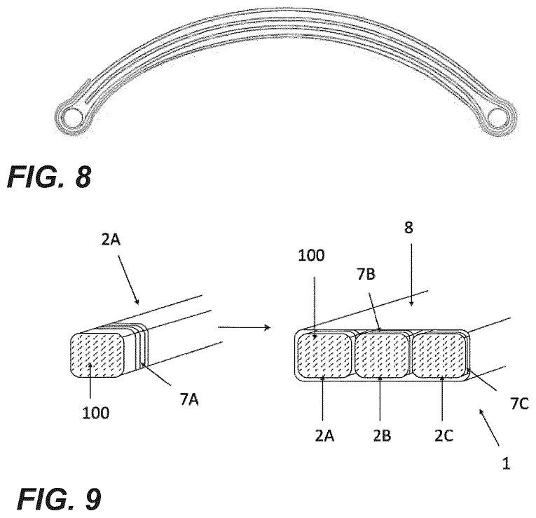

Additionally, the production of pre-impregnated fabric layers is not limited to the folding described above, as other types of folding can be carried out without departing from the scope of the present disclosure, such as concertina folding or winding one or more strips. FIG. 8 illustrates an example of winding a strip. The advantage of winding layup is its ease of automation.

Similarly, in the examples described above, the pre-impregnated fabric layers are produced with or without a folding technique. It goes without saying that a leaf spring 1 may be formed from a combination of layers resulting from folded strips and layers resulting from individual, unfolded strips.

In the examples shown, the layers and strips are shown separated from one another during or after production of the leaf spring, in order to facilitate understanding of the method. It goes without saying that the layers or strips are in contact with the directly adjacent layer or strip.

According to a variant shown in FIG. 9, the leaf spring 1 can be formed from a plurality of leaf bodies referred to as elementary leaf bodies 2A, 2B, 2C (three in the example shown) or, when the end pieces are integrated, leaves referred to as elementary one-piece leaves, produced according to the previously described method. More particularly, the leaf spring according to the non-limiting variant shown is produced according to the following steps:
a. producing the three elementary leaf bodies 2A, 2B, 2C:
   producing three series of unidirectional reinforcing fiber layers 100 to obtain leaf bodies, preferably having a thickness identical to the width of the layers, the fibers of the layers being shaped on the jig prior to assembly thereof,
   assembling the reinforcing fiber layers 100 of each series by lacing with at least one retaining fiber 7A, 7B, 7C,
b. impregnating the reinforcing fibers of each series with a matrix (e.g., epoxy resin),
c. bagging the three laterally contiguous and/or abutting leaf bodies in a structural element 8 (FIG. 9 shows contiguous leaf bodies).
d. curing the assembled reinforcing fibers.

The impregnation operation (step (b)) can advantageously be carried together with the curing operation (step (e)). The curing step can be carried out in a single operation, after step (d), or in two stages, with a first operation of curing the elementary leaf bodies prior to the bagging thereof and a second curing operation after the leaf bodies have been assembled together by bagging.

The bagging can be carried out, for example, with a fabric using the pre-impregnated or infusion technique. Other assembly techniques may be implemented without departing from the scope of the present disclosure. In particular, as an alternative to bagging, the elementary leaf bodies or elementary one-piece leaves can be glued together.

The advantage of a leaf spring produced from a plurality of elementary leaf bodies or elementary one-piece leaves is enhanced performance.

In the variant just described, the leaf bodies or elementary one-piece leaves have a square cross section. In one particularly advantageous embodiment, a leaf spring with a rectangular cross section can be produced from elementary leaf bodies or elementary one-piece leaves with a circular cross section. The advantage of a leaf spring made up of sub-portions (leaf bodies or elementary leaves) with a circular cross section is that it provides more efficient take-up of delamination forces. Specifically, since a disk is the shape with the best area-to-circumference ratio, any deformation of a circular cross section with a constant cross-sectional area (i.e., same amount of non-compressible material) necessarily leads to an increase in its circumference. By bagging sub-portions with a circular cross section, the circumferences are made undeformable, thereby preventing delamination effects.

Similarly, in the foregoing, the manufacturing method has been described according to a non-limiting example in which the unidirectional layers of fibers are pre-impregnated unidirectional fiber fabric layers. Of course, the method just described can equally be implemented in the same or similar way with dry fabric layers containing fibers, or with individually positioned fibers.

The present disclosure is described in the foregoing by way of example. It is understood that a person skilled in the art is able to produce different variant embodiments of the present disclosure without departing from the scope of the invention as defined by the claims.

1. A method for manufacturing a composite leaf spring that is elastically deformable between a rest state in which the leaf spring has a curved profile and a state of maximum extension in which the leaf spring has an elongate profile, a length of which corresponds to that of the neutral axis of the leaf spring, the leaf spring comprising a leaf body having a lower surface and, at each end, an attachment end piece for fastening the leaf spring to a suspension system, wherein the leaf body is produced by curing a fiber-reinforced matrix reinforced with reinforcing fibers, wherein prior to the curing of the matrix, deformable reinforcing fibers are applied to a support surface having a curvature that defines the lower surface of the leaf spring in the rest state, the reinforcing fibers being arranged in parallel with one another and extending along the curvature of the support surface in order to form, after curing, an arrangement of continuous reinforcing fibers that are parallel to one another and oriented in the longitudinal direction of the leaf body, at least at the lower surface of the leaf body.

2. The method of claim 1, wherein the leaf body is formed of one or more overlaid layers of reinforcing fibers.

3. The method of claim 2, wherein the one or more overlaid layers comprises a plurality of layers of fibers, the plurality of layers of fibers being obtained by one or more consecutive operations of folding, turning or winding one or more strips of fabric arranged on the support surface and containing unidirectional fibers extending in the longitudinal direction of the strips.

4. The method of claim 3, further comprising forming the attachment end pieces by arranging a pin on the one or more strips of fabric on either side of the support surface prior to folding, turning or winding.

5. The method of claim 1, further comprising securing the attachment end pieces to the leaf body after the leaf body has been produced.

6. The method of claim 1, further comprising lacing the reinforcing fibers with one or more retaining fibers over all or part of the length of the reinforcing fibers, the lacing being carried out in such a way as to arrange the one or more retaining fibers at a non-zero angle with respect to the orientation of the reinforcing fibers.

7. The method of claim 6, wherein the one or more retaining fibers are laced around the layers of reinforcing fibers at a point where the attachment end pieces join the leaf body.

8. The method of claim 6, wherein the non-zero angle is between 45 and 90 degrees.

9. The method of claim 6, wherein the one or more retaining fibers has a higher stiffness than the reinforcing fibers.

10. The method of claim 6, wherein the one or more retaining fibers is a carbon fiber.

11. The method of claim 1, further comprising assembling a plurality of elementary leaf bodies or elementary leaves provided with leaf bodies formed in one piece with the attachment end pieces, referred to as elementary one-piece leaves, arranged so as to be laterally contiguous with respect to one another and/or butted against one another.

12. The method of claim 1, wherein the reinforcing fibers are glass, KEVLAR®, aramid, polyethylene and/or PBO ZYLON® fibers.

13. A method for manufacturing a composite leaf spring, comprising:
applying deformable reinforcing fibers in a curable matrix to a support surface having a curvature that defines a lower surface of the leaf spring in a rest state, the reinforcing fibers being arranged in parallel with one another and extending along the curvature of the support surface to form an arrangement of continuous reinforcing fibers that are parallel to one another and oriented in the longitudinal direction of the leaf body;
curing the curable matrix to form a leaf body of the composite leaf spring, the composite leaf spring being elastically deformable between the rest state in which the leaf spring has a curved profile and a state of maximum extension in which the leaf spring has an elongate profile, a length of which corresponds to that of the neutral axis of the leaf spring; and
providing an attachment end piece at each end of the leaf body of the composite leaf spring for fastening the leaf spring to a suspension system.

14. The method of claim 13, wherein the applying the deformable reinforcing fibers in the curable matrix to the support surface comprises overlaying a plurality of layers of reinforcing fibers.

15. The method of claim 14, wherein the overlaying comprises at least one of folding, turning, or winding the plurality of layers of reinforcing fibers.

16. The method of claim 14, further comprising forming the attachment end pieces by arranging a pin on one or more layers of reinforcing fibers of the plurality on either side of the support surface prior to the at least one of folding, turning, or winding the plurality of layers of reinforcing fibers.

17. The method of claim 13, further comprising lacing the reinforcing fibers with one or more retaining fibers over all or part of the length of the reinforcing fibers, the lacing being carried out in such a way as to arrange the one or more retaining fibers at a non-zero angle with respect to the orientation of the reinforcing fibers.

18. The method of claim 17, wherein the non-zero angle is between 45 and 90 degrees.

19. The method of claim 17, wherein the one or more retaining fibers has a higher stiffness than the reinforcing fibers.

20. The method of claim 6, wherein the one or more retaining fibers comprises a carbon fiber.
